(19) United States
(12) Patent Application Publication
(10) Pub. No.: US 2005/0094396 A1
(43) Pub. Date: May 5, 2005

(54) Light emitting device for light-transmissive picture

(76) Inventors: Ta-Ming Chi, Hsinchu (TW); Ming-Se Teng, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/699,927

(22) Filed: Nov. 4, 2003

(51) Int. Cl. F21V 33/00

(52) U.S. Cl. 362/253

(57) ABSTRACT

A light emitting device for a light-transmissive picture includes a casing with the light-transmissive picture placed therein, a background light source unit in the housing; and a power supply supplying electrical power to the background light source for emitting a light, whereby the light-transmissive picture can be illuminated for better visibility. The light emitting device further comprises a decorative light source and a controller for controlling the decorative light source.

### FIELD OF THE INVENTION

The present invention relates to a light emitting device for light-transmissive picture, especially to a compact light emitting device for transparent picture and having versatile usage.

### BACKGROUND OF THE INVENTION

Image can convey more abundant meaning and concept than word can do. Conventionally, image playing device such as slide projector is used for presentation or demonstration.

As the progress of semiconductor manufacture skill, various innovations are developed to enrich the display and image-fetching field. For example, the digital camera is popular due to the maturity of charge coupled device (CCD) and the breaking through of while LED also provide new product idea.

For nowadays promotion advertisement or souvenir, photo or picture are usually adopted. However, the photo or picture are dull due to lack of sound and lightening effect.

### SUMMARY OF THE INVENTION

It is an object of the present invention to provide a compact light emitting device for transparent picture and having versatile usage.

To achieve the above objects, the present invention provides a light emitting device for a light-transmissive picture includes a casing with the light-transmissive picture placed therein, a background light source unit in the housing; and a power supply supplying electrical power to the background light source for emitting a light, whereby the light-transmissive picture can be illuminated for better visibility. The light emitting device further comprises a decorative light source and a controller for controlling the decorative light source.

According to one aspect of the present invention, the light emitting device further comprises voice IC or audio IC for better sound effect.

According to another aspect of the present invention, the light emitting device according to the present invention can be embodied in the form of tie clip or earring.

According to still another aspect of the present invention, the light emitting device according to the present invention can be integrated into watch or mobile phone, which are portable to user. The light emitting device according to the present invention also can be integrated to CD box or souvenir to increase the value thereof. The light emitting device 1 according to the present invention can also be assembled in plural form for decoration or use with mobile phone for incoming call notice.

The various objects and advantages of the present invention will be more readily understood from the following detailed description when read in conjunction with the appended drawing, in which:

### BRIEF DESCRIPTION OF DRAWINGS

FIG. 1 shows a front view of the light emitting device for light-transmissive picture according to the first preferred embodiment of the present invention;

FIG. 2 shows a sectional view of the light emitting device for light-transmissive picture according to the first preferred embodiment of the present invention;

FIG. 3 shows a block diagram of the light emitting device for light-transmissive picture according to the second preferred embodiment of the present invention;

FIG. 4 shows a front view of the light emitting device for light-transmissive picture according to the third preferred embodiment of the present invention; and

FIG. 5 shows a front view of the light emitting device for light-transmissive picture according to the fourth preferred embodiment of the present invention.

### DETAILED DESCRIPTION OF THE INVENTION

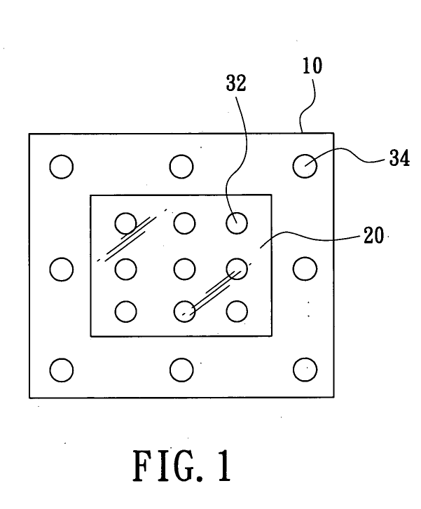

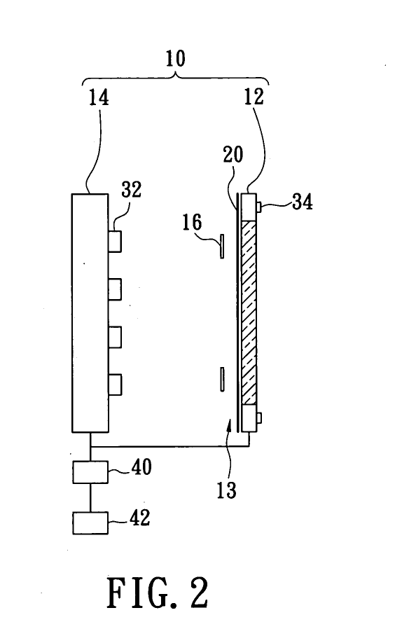

FIG. 1 shows a front view of the light emitting device for light-transmissive picture according to the first preferred embodiment of the present invention, and FIG. 2 shows a sectional view of the light emitting device for light-transmissive picture according to the first preferred embodiment of the present invention. The light emitting device 1 for light-transmissive picture according to the present invention mainly comprises a casing 10, a plurality of light sources 32, 34 and a controller 40.

As shown in FIG. 2, the casing 10 comprises a hollow front shell 12 and a rear shell 14. A plurality of retainers 16 is formed at rear side of the front shell 12 to define a recess 13 between the front shell 12 and the rear shell 14. The recess 13 is used to accommodate a light-transmissive picture 20. The light-transmissive picture 20 can be glass plate, acrylic plate, plastic plate or positive film plate. In the first preferred embodiment of the present invention, the light-transmissive picture 20 is a positive film plate.

With reference again to FIG. 1, the light sources include a background light source 32 mounted on the rear shell 14 and electrically connected to the controller 40, and a decorative light source 34 mounted on a front peripheral surface of the hollow front shell 12 and also electrically connected to the controller 40. The electrically connected to the controller 40 is electrically connected to a battery 42 besides connecting to the background light source 32 and the decorative light source 34. The battery 42 provides electric power to the controller 40, the background light source 32 and the decorative light source 34.

As shown in FIG. 1, after turning on a switch (not shown), electrical power is supplied from the battery 42 to the background light source 32 such that the light-transmissive picture 20 can be more clearly displayed. The background light source 32 can be, for example, white light LED. Moreover, a light-sensitive switch (not shown) can be provided on the light emitting device for light-transmissive picture. Therefore, the background light source 32 can be automatically turned on instead of manually turning on in a dark place. The controller 40 can be programmed to control a flashing mode of the decorative light source 34. The decorative light source 34 can be LED or primitive color (red, blue or green color), or LED of other colors to enhance decorative effect of the light emitting device for light-transmissive picture.

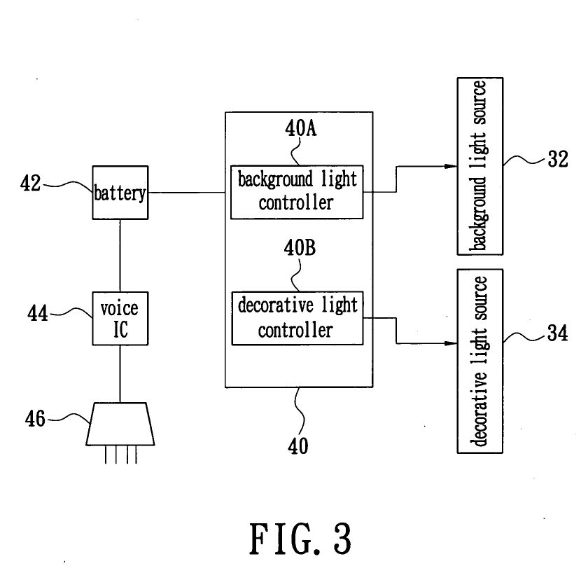

FIG. 3 shows a block diagram of the light emitting device 1 for light-transmissive picture according to the second preferred embodiment of the present invention. The light emitting device 1 has similar components as that shown in the first preferred embodiment except that the controller 40 is composed of a background light controller 40A and a decorative light controller 40B for controlling the background light source 32 and the decorative light source 34, respectively. The light emitting device 1 further comprises a voice IC 44 connected to a loudspeaker 46. The voice IC 44 can be controlled by the e controller 40 to speak a predetermined speech. The voice IC 44 can also be replaced by an audio IC to play music.

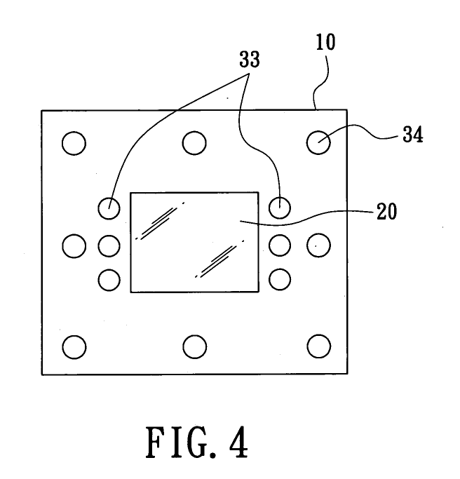

FIG. 4 shows a front view of the light emitting device 1 for light-transmissive picture according to the third preferred embodiment of the present invention. The light emitting device 1 shown in FIG. 4 comprises a casing 10 and a plurality of light sources 33, 34 inducing background light source 33 and decorative light source 34. The background light sources 33 are arranged on both sides of a rear shell 14 of the casing 10 and electrically connected to a battery 42 of a controller for obtaining electrical power therefrom. The background light source 33 emits light toward both sides of a light-transmissive picture 20 for manifest the display of the light-transmissive picture 20.

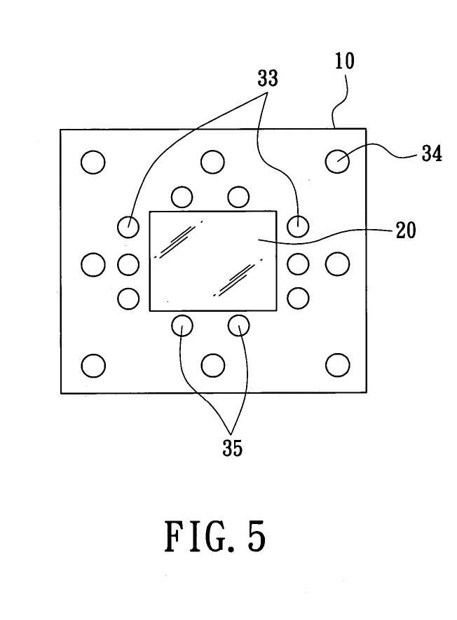

With reference to FIGS. 2 and 5, FIG. 5 shows a front view of the light emitting device 1 for light-transmissive picture according to the fourth preferred embodiment of the present invention. The light emitting device 1 according to this embodiment has similar components as previously embodiments. The light emitting device 1 shown in FIG. 5 comprises a casing 10 and a plurality of light sources 33, 34 and 35 inducing background light source 33, 35 and decorative light source 34. The background light sources 33, 35 are arranged on a rear shell 14 of the casing 10 and on peripheral locations with respect to the light-transmissive picture 20. The background light source 33, 35 emits light toward peripheral sides of a light-transmissive picture 20 for manifest the display of the light-transmissive picture 20.

In application, the light emitting device 1 according to the present invention can be embodied in the form of tie clip or earring. For example, user can place idol's photo in the form of the light-transmissive picture 20 on the light emitting device 1 when they attend a party. The light emitting device 1 with idol's photo can create fantastic effect.

Moreover, the light emitting device 1 according to the present invention has the advantage of miniature size. Therefore, the light emitting device 1 according to the present invention can be integrated into watch or mobile phone, which are portable to user. The light emitting device 1 according to the present invention also can be integrated to CD box or souvenir to increase the value thereof. The light emitting device 1 according to the present invention can also be assembled in plural form for decoration or use with mobile phone for incoming call notice.

Although the present invention has been described with reference to the preferred embodiment thereof, it will be understood that the invention is not limited to the details thereof. Various substitutions and modifications have suggested in the foregoing description, and other will occur to those of ordinary skill in the art. For example, the background light source and decorative light source can also adopt EL light source. The light-transmissive picture can be attached to a front face of the light emitting device. Therefore, all such substitutions and modifications are intended to be embraced within the scope of the invention as defined in the appended claims.

1. A light emitting device for light-transmissive picture, comprising
a casing having a front face and an opposite rear face;
a background light source unit in the housing; and
a power supply supplying electrical power to the background light source for emitting a light, whereby the light-transmissive picture can be illuminated for better visibility.

2. The light emitting device for light-transmissive picture as in claim 1, wherein a recess is defined at one lateral side of the front face for receiving the light-transmissive picture.

3. The light emitting device for light-transmissive picture as in claim 1, wherein the light-transmissive picture is attached to the front face.

4. The light emitting device for light-transmissive picture as in claim 1, wherein the background light source is LED.

5. The light emitting device for light-transmissive picture as in claim 1, further comprising a decorative light source.

6. The light emitting device for light-transmissive picture as in claim 5, further comprising a controller to control a lighting mode of the decorative light source.

7. The light emitting device for light-transmissive picture as in claim 0.5, wherein the decorative light source is LED.

8. The light emitting device for light-transmissive picture as in claim 1, further comprising a voice IC connected to the power source.

9. The light emitting device for light-transmissive picture as in claim 8, further comprising a loud speaker connected to the voice IC.

10. The light emitting device for light-transmissive picture as in claim 1, further comprising an audio IC connected to the power source.

11. The light emitting device for light-transmissive picture as in claim 10, further comprising a loud speaker connected to the audio IC.

12. The light emitting device for light-transmissive picture as in claim 1, further comprising a light-sensitive switch.

13. The light emitting device for light-transmissive picture as in claim 1, wherein the light-transmissive picture is a transparent picture.

14. The light emitting device for light-transmissive picture as in claim 13, wherein the light-transmissive picture is one of glass plate, acrylic plate, plastic plate and positive film plate.
